(19) United States
(12) Patent Application Publication
(10) Pub. No.: US 2009/0237691 A1
(43) Pub. Date: Sep. 24, 2009

(54) IMAGE PROCESSING APPARATUS, IMAGE PROCESSING METHOD AND IMAGE FORMING APPARATUS

(75) Inventor: Keiko Kanamori, Numazu-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/402,708

(22) Filed: Mar. 12, 2009

Related U.S. Application Data
(60) Provisional application No. 61/037,573, filed on Mar. 18, 2008.

(51) Int. Cl. H04N 1/60; G06F 3/12

(52) U.S. Cl. 358/1.9; 358/1.15

(57) ABSTRACT

An image processing apparatus includes an adjustment data setting unit which sets base adjustment data used to readjust a density of a part having a lower density than a predetermined density of image data to a lower value with respect to a printer driver which generates print data, a data input unit which receives the image data and the base adjustment data from the print driver, and a base adjustment unit which executes base adjustment in a predetermined part of the image data in accordance with the base adjustment data. The base adjustment data includes information designating a data attribute of the predetermined part where base adjustment is carried out, and information designating a level of the base adjustment.

### CROSS-REFERENCE TO RELATED APPLICATION

This application is based upon and claims the benefit of U.S. Provisional Application No. 61/037,573, filed on Mar. 18, 2008.

### TECHNICAL FIELD

The present invention relates to an image processing technique for adjusting the base of an image.

### BACKGROUND

In a processing apparatus such as a computer, an image picked up by a digital camera or an image scanned by a scanner can be taken in to generate a document, and the generated document can be printed.

Generally, an image forming apparatus such as a digital copy machine which outputs an image acquired by scanning an original using a scanner is equipped with a function to automatically adjust to image density adapted to the original if the original has a base or includes light letters. Moreover, a technique of processing according to the state of the original instead of unconditionally eliminating base fog is disclosed (JP-A-2001-103310).

A user observes a document prepared by taking in an image, as a whole, and determines whether the document is printed in a desirable state or not. Therefore, it is desired that the user can conveniently process base fog in accordance with each state. That is, if a document is to be generated and printed incorporating an image with base fog which is inputted from a scanner, digital camera or the like, it should be possible to conveniently process the base fog of the image to a level intended by the user.

### SUMMARY

According to a first aspect of the invention, an image processing apparatus includes: an adjustment data setting unit which sets base adjustment data used to readjust a density of a part having a lower density than a predetermined density of image data to a lower value with respect to a printer driver which generates print data; a data input unit which receives the image data and the base adjustment data from the print driver; and a base adjustment unit which executes base adjustment in a predetermined part of the image data in accordance with the base adjustment data. The base adjustment data includes information designating a data attribute of the predetermined part where base adjustment is carried out, and information designating a level of the base adjustment.

According to a second aspect of the invention, an image processing method includes: setting base adjustment data used to readjust a density of a part having a lower density than a predetermined density of image data to a lower value with respect to a printer driver which generates print data; receiving the image data and the base adjustment data from the print driver; and executing base adjustment in a predetermined part of the image data in accordance with the base adjustment data. The base adjustment data includes information designating a data attribute of the predetermined part where base adjustment is carried out, and information designating a level of the base adjustment.

According to a third aspect of the invention, an image forming apparatus includes: an input unit which inputs image data; an adjustment data setting unit which sets base adjustment data used to readjust a density of a part having a lower density than a predetermined density of the image data to a lower value; a data input unit which receives the image data and the base adjustment data; a base adjustment unit which executes base adjustment in a predetermined part of the image data in accordance with the base adjustment data; and an image forming unit which generates a printed matter from the base-adjusted image data. The base adjustment data includes information designating a data attribute of the predetermined part where base adjustment is carried out, and information designating a level of the base adjustment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows an exemplary configuration of a tandem MFP equipped with an image processing apparatus.

FIG. 2 is a block diagram showing the internal configuration of the MFP.

FIG. 3 shows an appearance of an operation panel provided on the MFP.

FIG. 4 shows a configuration of an image processing system using the MFP.

FIG. 5 is a block diagram showing an exemplary configuration of a printer controller in the MFP.

FIG. 6 shows a document in which base adjustment is to be carried out.

FIG. 7 shows an image quality details setting screen.

FIG. 8 shows conversion characteristics for base adjustment.

FIG. 9 shows a document after base adjustment.

FIG. 10 illustrates another example of a conversion method.

FIG. 11 illustrates a method of designating a base adjustment value on a page basis.

FIG. 12 illustrates a method of designating a base adjustment value on an attribute basis.

FIG. 13 illustrates a method of specifying an area and designating a base adjustment value for the area.

FIG. 14 illustrates a method for a user to directly change a conversion characteristic curve.

### DETAILED DESCRIPTION

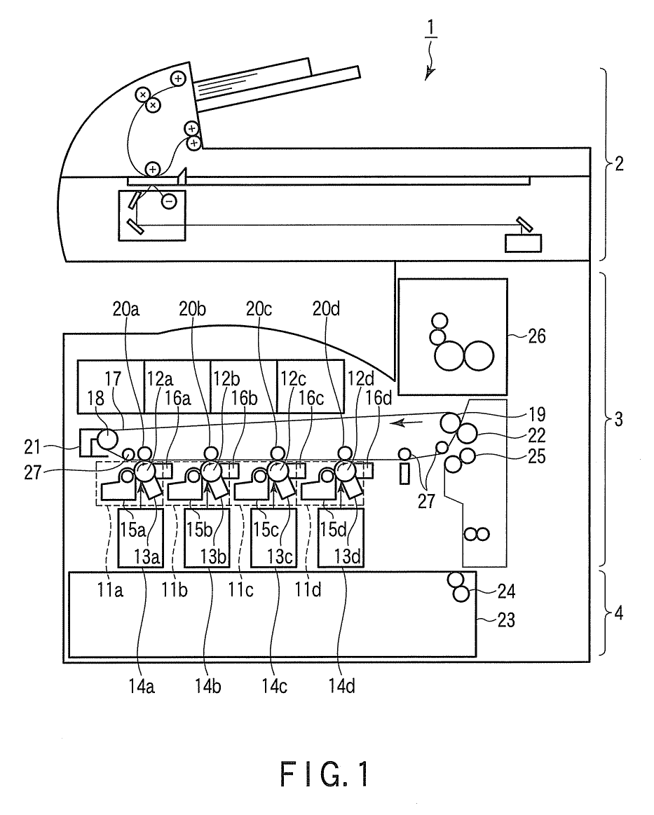

FIG. 1 shows an exemplary configuration of a tandem multi-function peripheral (MFP) 1 equipped with an image processing apparatus. As shown in FIG. 1, the MFP 1 includes a scanner 2, an image forming unit 3, and a paper supply unit 4.

The scanner 2 casts light to an original set on an original table, guides reflected light from the original to a light receiving element via plural optical components, performs photoelectric conversion, and supplies an image signal to the image forming unit 3.

The image forming unit 3 is provided with four process cartridges 11a, 11b, 11c and 11d. The process cartridges 11a, 11b, 11c and 11d correspond to yellow (Y), magenta (M), cyan (C) and black (K), respectively, and have photoconductive drums 12a, 12b, 12c and 12d, respectively. The image forming unit 3 forms a toner image on these photoconductive drums 12a, 12b, 12c and 12d.

The photoconductive drum 12a is a cylinder rotating in the direction of an arrow in FIG. 1. A charger 13a faces the surface of the photoconductive drum 12a. The charger 13a uniformly and negatively charges the photoconductive drum 12a. An exposure device 14a exposes the photoconductive drum 12a charged by the charger 13a to light in order to form an electrostatic latent image. The exposure device 14a exposed the photoconductive drum 12a by using a laser beam to which light modulation is carried out corresponding to an image signal supplied from the scanner 2. The exposure device 14a may use an LED (light emitting diode) instead of a laser beam.

Downstream of the exposure device 14a, a developing device 15a inversely develops the electrostatic latent image formed by the exposure device 14a. A yellow (Y) developer is housed in the developing device 15a.

Downstream of the developing device 15a, an intermediate transfer belt 17 contacts the photoconductive drum 12a.

The intermediate transfer belt 17 has a length (width) equal to the length of the photoconductive drum 12a in its axial length, in the direction (direction of depth in FIG. 1) orthogonal to the carrying direction. The intermediate transfer belt 17 is laid over a driving roller 18 which turns the belt, and a secondary transfer counter-roller 19 as a driven roller. Tension rollers 27 located downstream of the driving roller 18 maintain the intermediate transfer belt 17 under a constant tension.

A toner cleaner 16a is provided further downstream of the contact position of the photoconductive drum 12a and the intermediate transfer belt 17. The toner cleaner 16a removes residual toner on the photoconductive drum 12a by a cleaning blade after toner is transferred to the intermediate transfer belt 17.

Between the driving roller 18 and the secondary transfer counter-roller 19, the process cartridges 11a, 11b, 11c and 11d are sequentially arranged along the carrying direction of the intermediate transfer belt 17. The process cartridges 11b, 11c and 11d have same structure as the process cartridge 11a.

That is, the photoconductive drums 12b, 12c and 12d are located at the center of their respective process cartridges. Chargers 13b, 13c and 13d face the surface of the photoconductive drums 12b, 12c and 12d, respectively. Downstream of the chargers 13b, 13c and 13d, exposure devices 14b, 14c and 14d expose the charged photoconductive drums 12b, 12c and 12d and form an electrostatic latent image thereon. Further downstream of the exposure devices 14b, 14c and 14d, developing devices 15b, 15c and 15d inversely develop the electrostatic latent images formed by the exposure devices 14b, 14c and 14d, respectively. Toner cleaners 16b, 16c and 16d are provided downstream of the contact positions of the photoconductive drums 12b, 12c and 12d and the intermediate transfer belt 17. The developing devices 15b, 15c and 15d house a magenta (M) developer, a cyan (C) developer and a black (K) developer, respectively.

The intermediate transfer belt 17 sequentially contacts each of the photoconductive drums 12a to 12d. Primary transfer rollers 20a, 20b, 20c and 20d are provided corresponding to the photoconductive drums 12a to 12d. The primary transfer rollers 20a to 20d contact the back side of the intermediate transfer belt 17 above their corresponding photoconductive drums. The primary transfer rollers 20a, 20b, 20c and 20d face the process cartridges 11a to 11d via the intermediate transfer belt 17. The primary transfer rollers 20a to 20d are positively (+) charged. The charged primary transfer rollers 20a to 20d transfer the toner images on the surface of the photoconductive drums 12a to 12d to the intermediate transfer belt 17.

An intermediate transfer belt cleaner 21 removes residual toner on the intermediate transfer belt 17.

Below the image forming unit 3, a paper supply cassette 23 of the paper supply unit 4 houses sheets of paper. A pickup roller 24 picks up the sheets one by one from the paper supply cassette 23. A secondary transfer roller 22 and the secondary transfer counter-roller 19 face each other via the intermediate transfer belt 17 held between them. A pair of registration rollers 25 supplies a sheet to the space between the secondary transfer roller 22 and the intermediate transfer belt 17 in predetermined timing. Above the intermediate transfer belt 17, a fixing device 26 fixes the toner image to the sheet.

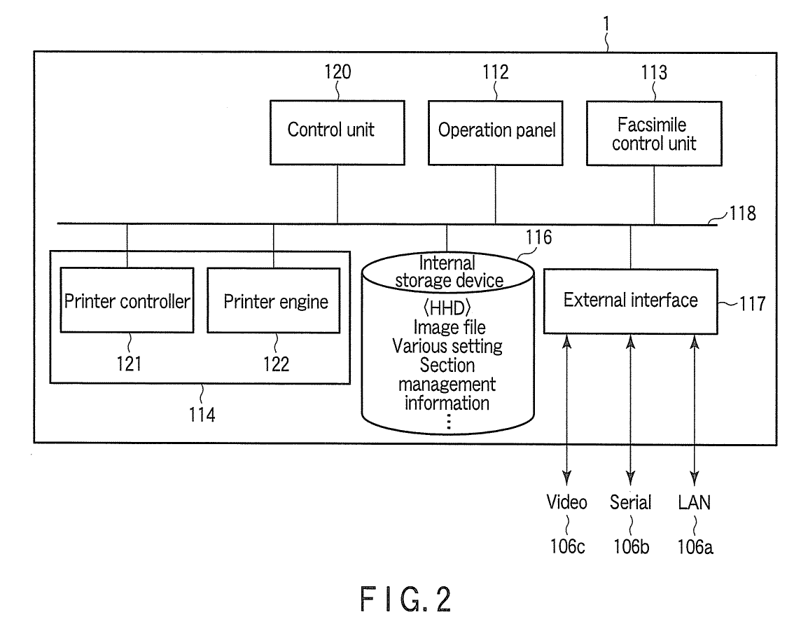

FIG. 2 is a block diagram showing the internal configuration of the MFP 1.

The MFP 1 has an operation panel 112, a facsimile control unit 113, a printer 114, an internal storage device 116, an external interface 117, a system bus 118 and a control unit 120.

The operation panel 112 takes in instructions of setting and execution of various functions inputted by the user, and also displays or notifies the user of necessary information. The facsimile control unit 113 is an interface for facsimile communications with an external device (not shown) via a public telephone network PSTN.

The printer 114 has a printer controller 121 and a printer engine 122. The printer controller 121 performs image processing to image data taken in by the scanner 2. The printer engine 122 controls the image forming unit 3 to output an image onto a sheet. The internal storage device 116 is a storage medium such as an HDD installed within the MFP 1. Image files, various setting information, section management information and so on are saved in this internal storage device 116. The external interface 117 is an interface for transmission and reception of various setting information, control information and image data to and from an external controller (not shown). The control unit 120 controls each part of the hardware connected via the system bus 118.

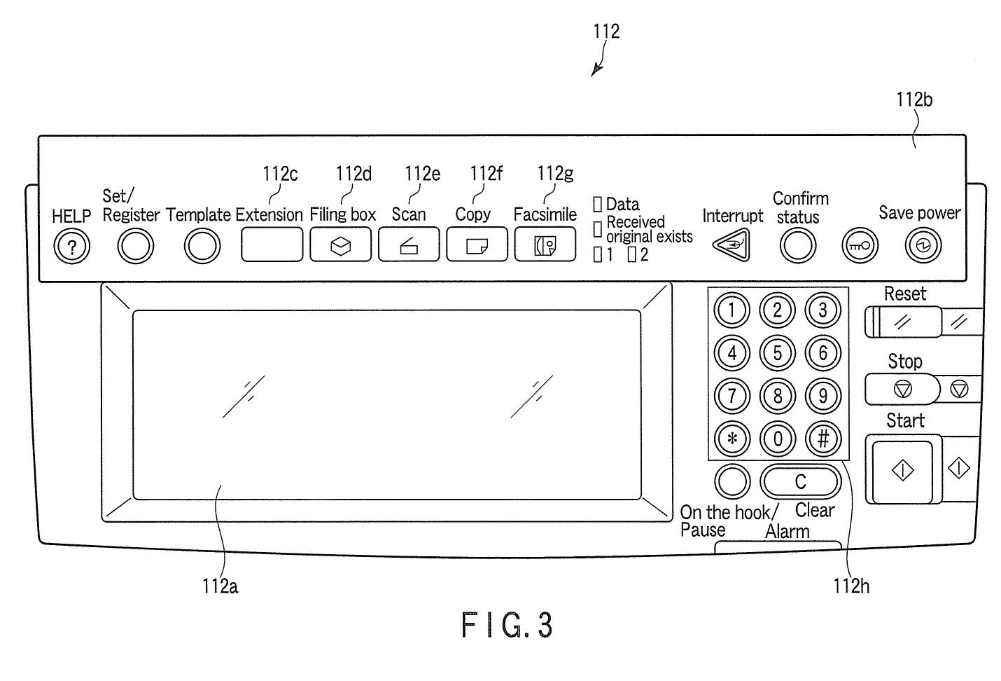

FIG. 3 shows an appearance of the operation panel 112 provided on the MFP 1.

The user carries out setting and confirmation of the MFP 1 via this operation panel 112.

A touch panel 12a and an operation input unit 12b are provided on the operation panel 112.

On the touch panel 12a, the state of the MFP 1, operation procedures, various instructions to the user and so on are displayed.

In the operation input unit 12b, various operation buttons are provided for operating the MFP 1.

As keys for selecting a function and calling a setting screen, an extension button 112c, a filing box button 112d, a scan button 112e, a copy button 112f, a facsimile button 112g and so on are arranged. In addition, numeric keys 112h for inputting a set value and for confirming information are arranged as well.

The functions of the main buttons of these operation buttons will now be explained.

The extension button 112c is operated for using an extension. The filing box button 112d is used for taking out saved image data. The scan button 112e is used for the scan function. The copy button 112f is used for using the copy function. The facsimile button 112g is used for using the facsimile function. The ten keys 112h are used for inputting numbers.

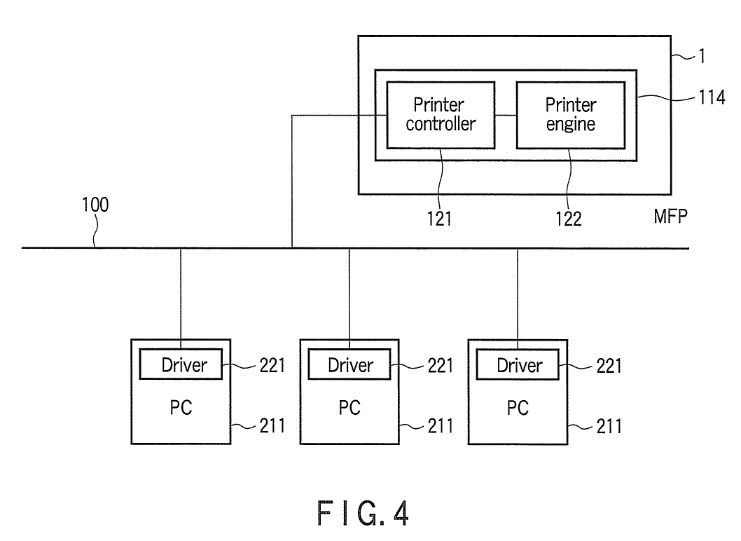

FIG. 4 shows a configuration of an image processing system using the MFP 1.

In the system shown in FIG. 4, a computer terminal (PC) 211 connected to a network 100 transfers PDL (Page Description Language) data or raster data representing the structure of image data to the printer 114, which is a part of the functions of the MFP 1. That is, the PC 211 transfers PDL data or raster data to the printer controller 121 from a printer driver 221 in accordance with interface characteristics with the printer 114. The PC 211 also transmits base adjustment data (later described in detail) for base processing to the printer 114 together with the PDL data.

In the printer 114, the printer controller 121 controls driving of the printer engine 122. The printer controller 121 unfolds the PDL data sent from the PC 211 into a bitmap and executes various image processing. The printer engine 122 converts the bitmap image data from the printer controller 121 to a driving signal, then carries a sheet, performs laser driving control and so on, and carries out print operation.

The printer controller 121 can analyze the attribute of each object, perform optimum image processing for each object, and combine and output the result.

The PC 211 and the printer 114 need not necessarily connected via a network and may be connected via a USB (Universal Serial Bus). The PC 211 and the printer 114 may be connected in one-to-one correspondence. The interface between the printer controller 121 and the printer engine 122 depends on the architecture of the printer.

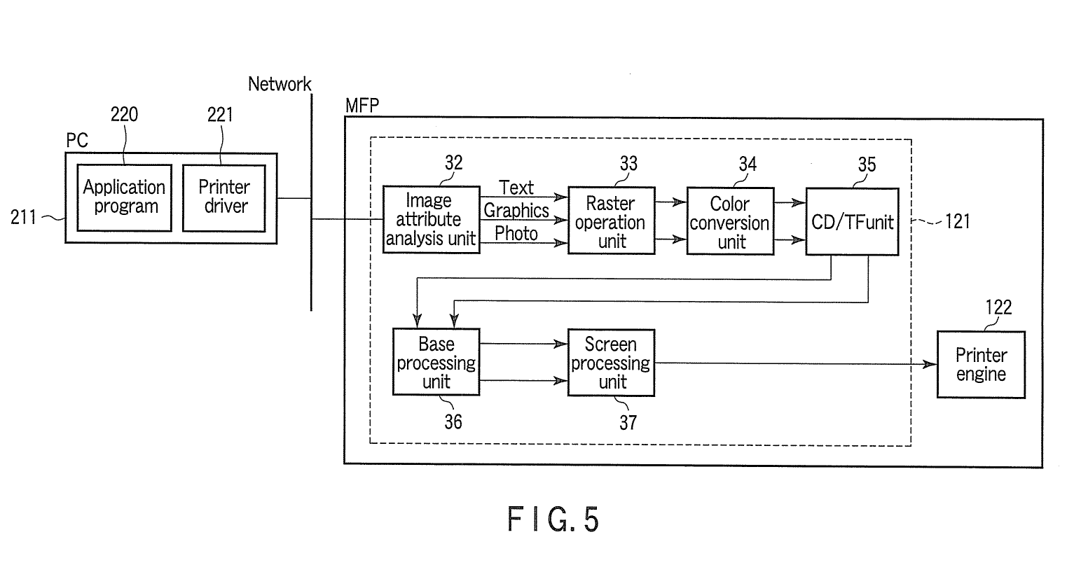

FIG. 5 is a block diagram showing an exemplary configuration of the printer controller 121 in the MFP 1. The printer controller 121 has an image attribute analysis unit 32, a raster operation unit 33, a color conversion unit 34, a CD-TF unit 35, a base processing unit 36, and a screen processing unit 37.

PDL data transferred from the printer driver 221 in accordance with a print command in an application program 220 of the PC 211 is transferred to the printer controller 121 via the network. In the printer controller 121, the image attribute analysis unit 32 analyzes the attribute of an image from the received PDL data and classifies its type. Basically, if roughly classified, image data has one of text, graphic and image bitmap attributes. With respect to the attribute of the classified data, the attribute of each type is allocated as a tag and is handed over to the subsequent processing. For example, if image data has the above three types of attributes, tag data of 2 bits is necessary.

The raster operation unit 33 converts PDL data to bitmap data. For example, in the case of monochrome print, PDL data is converted to single-color bitmap data of 8 bits. In the case of color print, PDL data is converted to bitmap data with each color having 8 bits. To each bitmap data, tag data corresponding to its position is allocated as well.

The color conversion unit 34 converts the converted RGB color signals with each color having 8 bits, which are standard signals in a monitor, to CMY colors or CMYK colors, which are reproduction colors in a printer. R, G and B represent red, green and blue, respectively. C, M, Y and K represent cyan, magenta, yellow and black, respectively. In the example shown in FIG. 5, the color conversion unit 34 switches processing of color conversion in accordance with the attribute of each image based on tag data. If the output device is a monochrome printer, the color conversion unit 34 is not necessary.

The CD-TF unit 35 carries out gamma conversion to the bitmap-converted image in order to acquire calibration of image density corresponding to the characteristics of the printer engine 122 and preferred gradation characteristics. The CD-TF unit 35 carries out gamma conversion in accordance with the image characteristics for each object and tag data.

The base processing unit 36 adjusts base fog for image data designated in accordance with base adjustment data. The screen processing unit 37 converts data of 1 pixel to image data with the number of gradation levels equivalent to the number of bits corresponding to the print capability of the image forming unit 3, for example, by halftone processing using a threshold matrix.

The printer engine 122 converts the image data to PWM (pulse width modulation) signals to drive the laser and forms an image.

Next, a base processing method using the image processing apparatus according to the embodiment will be described.

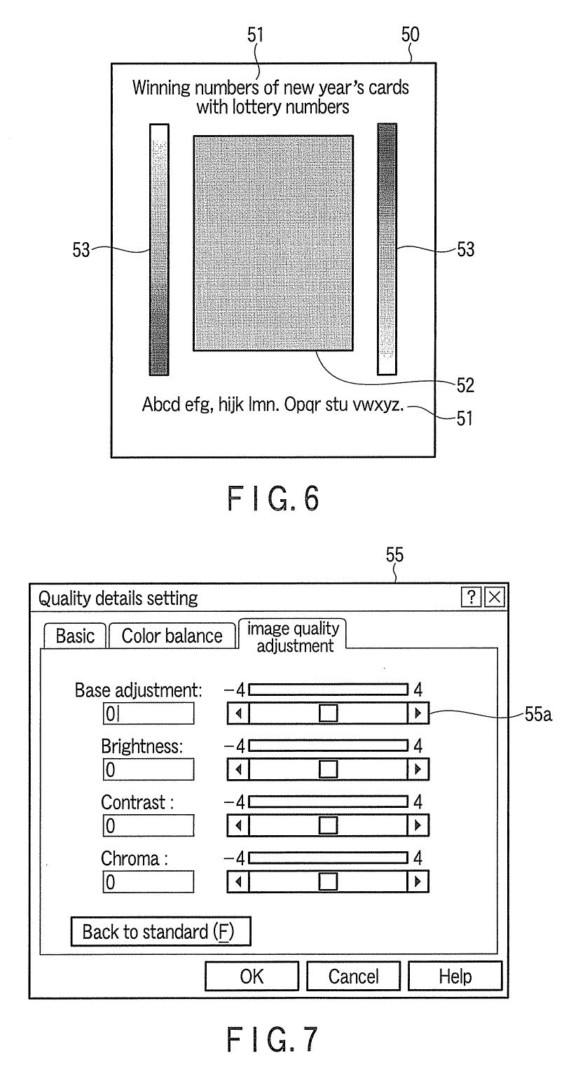

FIG. 6 shows a document 50 for which base adjustment is to be carried out. This document 50 includes text data 51 showing the winning numbers of New Year's cards with lottery numbers, photograph data 52 acquired by shooting the winning numbers, and graphic data 53.

The document 50 shown in FIG. 6 is acquired by printing without base processing. In this document 50, the winning numbers do not appear clearly because of base fog in the photograph data 52. Thus, the user instructs the printer driver 221 to perform base fog processing only to the photograph data 52, by using the PC 211.

First, the user outputs an instruction to print the document 50, to the printer driver 221 from the application program 220. Then, the printer driver 221 displays an image quality details setting screen 55 shown in FIG. 7 on the display (not shown). Using a pull-down menu, not shown, the user designates an attribute which is a target of base adjustment from text, photograph and graphics. Then, the user moves a base adjustment slide bar 55a in the image quality details setting screen 55 to left and right and thus sets a base adjustment value. The base adjustment value can be set within the range of −4 to +4.

The attribute and base adjustment value thus set of the data which is a target of base adjustment are outputted to the printer controller 121 as base adjustment data. The base processing unit 36 executes base adjustment using this base adjustment data.

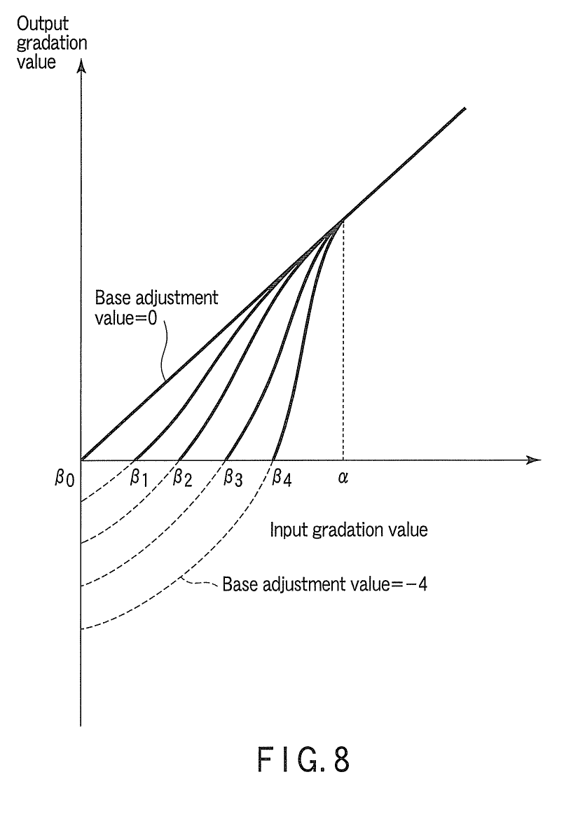

FIG. 8 shows conversion characteristics for base adjustment. The horizontal axis represents input gradation value. The vertical axis represents output gradation value after conversion. Here, a low gradation value indicates a low density. As for characteristic curves for gradation conversion, output gradation values are virtually defined also in the negative domain, as shown in FIG. 8. However, if the output gradation value is less than 0, conversion is carried out with the output gradation value equal to 0. In this example, since processing to remove the base is carried out, the base adjustment value is set within the range of −4 to 0.

If the base adjustment value is 0, an input gradation value is linearly converted to an output gradation value. In FIG. 8, the straight line passing through the origin represents the conversion characteristic for the base adjustment value equal to 0. Meanwhile, if the base adjustment value is set to a value smaller than 0, the conversion characteristic between an input gradation value and an output gradation value is nonlinear.

With the characteristics shown in FIG. 8, if the base value adjustment value is −1, an input gradation value is converted to an output gradation value in the following manner. Input gradation values of 0 to β1 are converted to the output gradation value of 0. Input gradation values equal to and greater than a are linearly converted to output gradation values. The conversion characteristic of input gradation values of β1 to α is defined by a curve (including a straight line) having continuous output gradation values.

If the base adjustment value is −2, input gradation values of 0 to β2 are converted to the output gradation value of 0. If the base adjustment value is −3, input gradation values of 0 to β3 are converted to the output gradation value of 0. If the base adjustment value is −4, input gradation values of 0 to β4 are converted to the output gradation value of 0. If the base adjustment value is 0, β0=0 holds and input gradation values are linearly converted to output gradation values as described above.

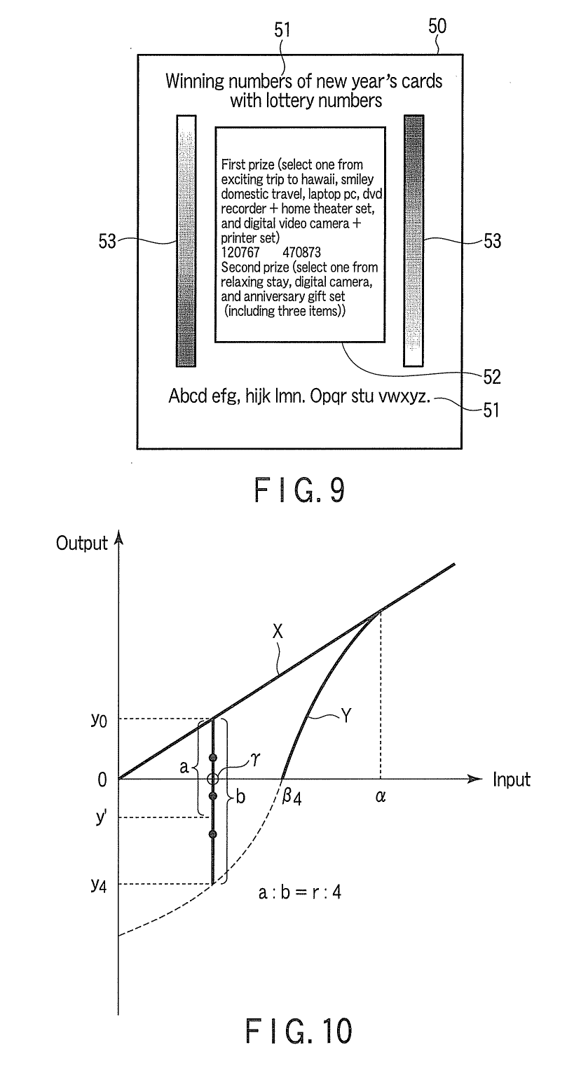

As the value of β is thus changed in accordance with the base adjustment value set by the user, the range of removing base fog can be adjusted. That is, the base processing unit 36 executes gradation conversion to data having a photograph attribute, which is a target of base adjustment, in accordance with the characteristic prescribed by the base adjustment value. FIG. 9 shows the document 50 after base adjustment. Base processing is carried out only to the photograph data 52 in accordance with base adjustment data.

The conversion for base adjustment can also be realized by using a LUT (lookup table), not shown, or can be realized by operations using the constants α, β1, β2, β3 and β4.

FIG. 10 illustrates another exemplary conversion method. In this example, the conversion characteristics (curves X and Y) for a base adjustment value=0 and a base adjustment value=−4 are defined. In the curve Y, which shows the conversion characteristic for the base adjustment value=−4, output gradation values are defined also in the negative domain. If a base adjustment value=−γ is set, output gradation values y0 and y4 are found from the defined two curves X and Y. Then, a value y′ is calculated by interpolating the ratio of γ to 4 in the found output gradation values y0 and y4. If y′>0 holds, the output gradation value is y′. If y′≦0 holds, the output gradation value is 0.

With this conversion method, base adjustment values are not limited to integrals. Since the user can designate continuously changed values, finer base adjustment can be realized.

Here, the user determines and sets an appropriate base adjustment value for each document 50. The user then refers to the outputted document 50, and when it is determined that further base adjustment is necessary, the user updates the base adjustment value and outputs the document 50 again. Thus, the desired document 50 can be acquired. Meanwhile, if it is known that photograph data used in the document 50 needs base adjustment, the user can set base adjustment without outputting the document 50.

To designate base adjustment values via the user interface (UI) of the printer driver 221, various methods can be employed.

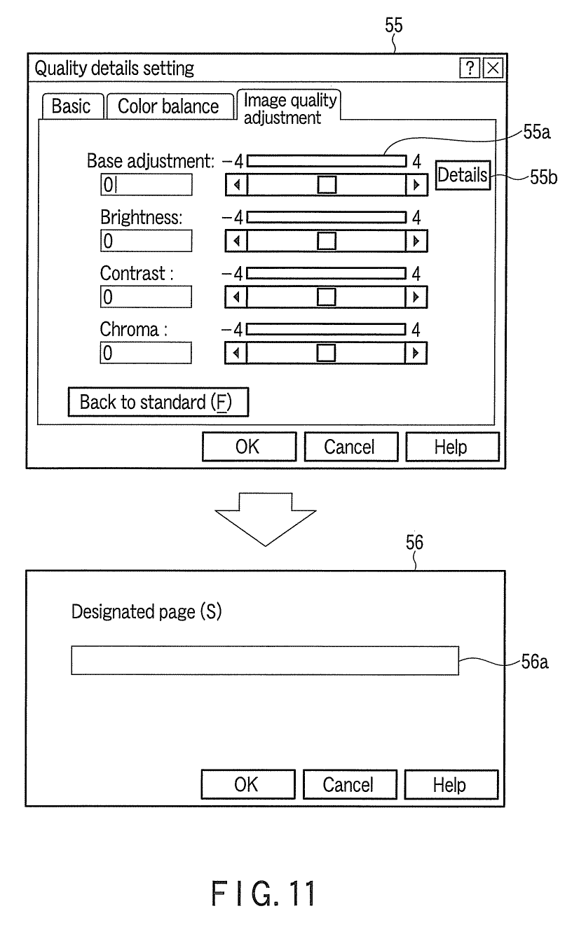

FIG. 11 illustrates a method of designating a base adjustment value on the page basis.

As the user presses a details setting button 55b provided in the image quality details setting screen 55, a page designation screen 56 is displayed. The user inputs a page number or a page range in a designated page input section 56a and operates the OK button. Thus, the set base adjustment value is applied to the inputted page or pages of the document 50. At this time, the data attribute, which is a target of base adjustment, the base adjustment value, and the target page(s) are outputted to the printer controller 121 as base adjustment data. The base processing unit 36 adjusts base fog in accordance with the base adjustment data.

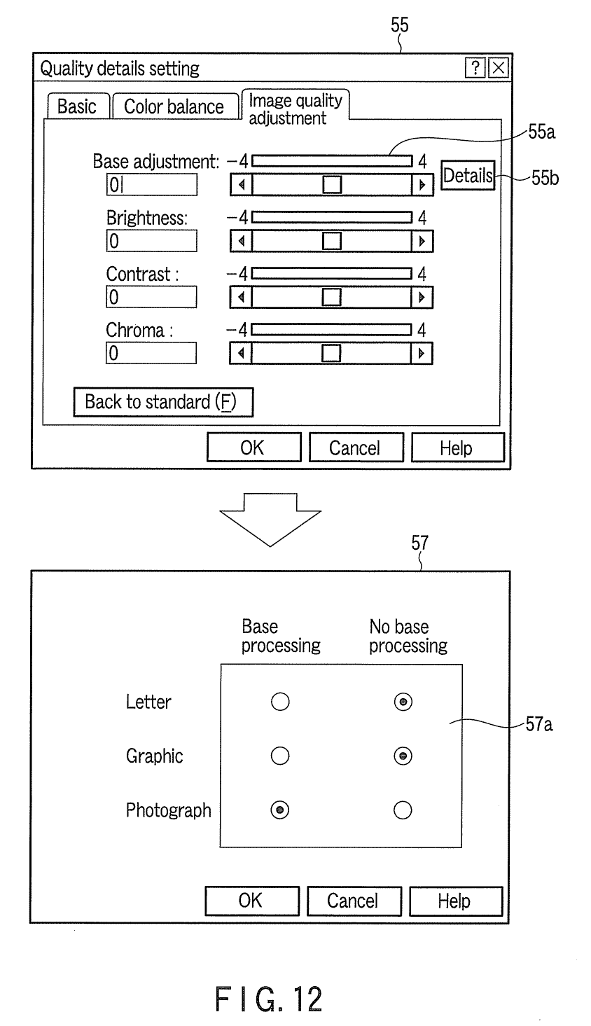

FIG. 12 illustrates a method of designating a base adjustment value on the attribute basis.

If the details setting button 55b provided in the image quality details setting screen 55 is pressed, an attribute designation screen 57 is displayed. In an input section 57a provided for each attribute of letter, graphic, and photograph, whether to carry out base processing or not is inputted and the OK button is operated. Thus, the base adjustment value is applied to the inputted attribute data of the document 50. At this time, at least one data attribute, which is a target of base adjustment, and the base adjustment value are outputted to the printer controller 121 as base adjustment data. The base processing unit 36 adjusts base fog in accordance with the base adjustment data.

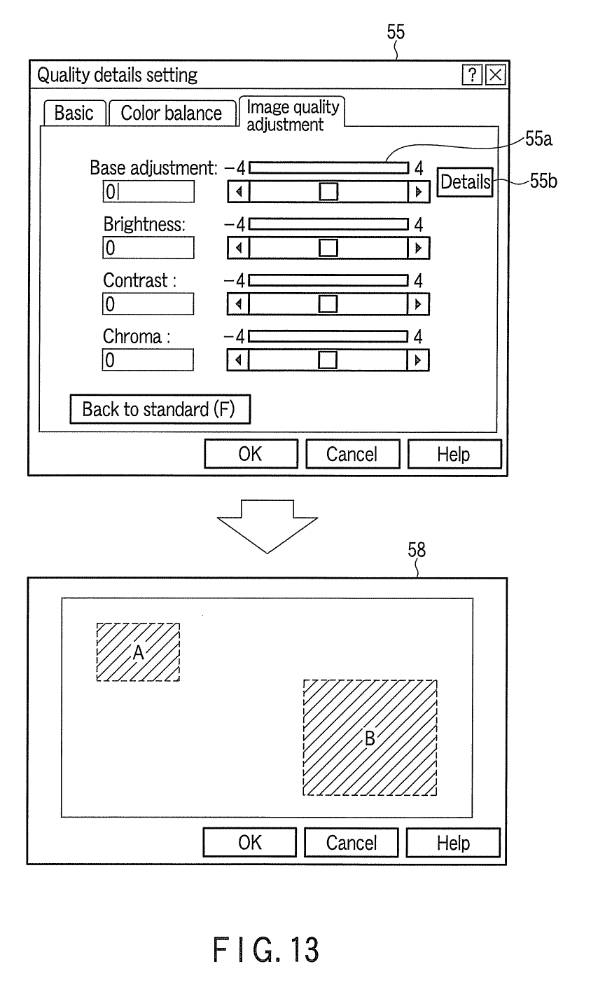

FIG. 13 illustrates a method of specifying an area and designating a base adjustment value for the area.

As the details setting button 55b provided in the image quality details setting screen 55 is pressed, a preview screen 58 is displayed. A preview of the document 50 is displayed in this preview screen 58. If the user designates an area by using a mouse and then operates the OK button, the base adjustment value is applied to the data in the specified area. At this time, the data attribute, which is a target of base adjustment, the base adjustment value, and the data designating the area are outputted to the printer controller 121 as base adjustment data. The base processing unit 36 adjusts base fog in accordance with the base adjustment data.

The user can directly change the conversion characteristic curve used for base adjustment.

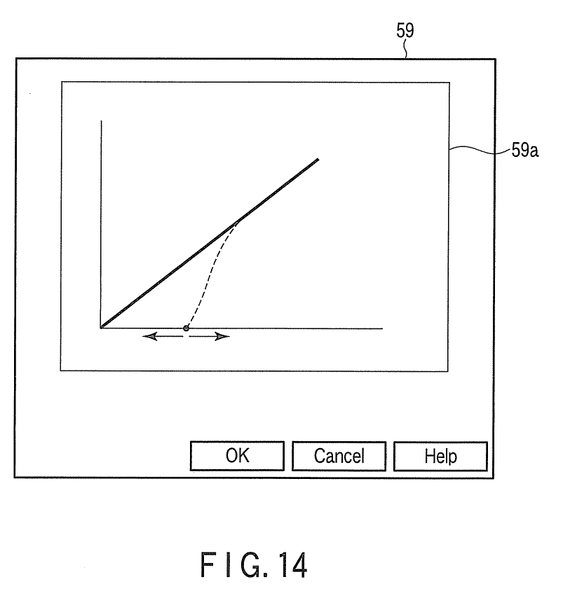

FIG. 14 illustrates a method for the user to directly change a conversion characteristic curve.

If the details setting button 55b provided in the image quality details setting screen 55 is pressed, a characteristic change screen 59 is displayed. In this characteristic change screen 59, a conversion characteristic curve corresponding to a base adjustment value set in the image quality details setting screen 55 is drawn. The user can directly change this characteristic curve by using a mouse. As the user operates the OK button, base adjustment according to the changed characteristic is carried out. At this time, the data attribute, which is a target of base adjustment, the base adjustment value, and the changed characteristic curve are outputted to the printer controller 121 as base adjustment data. The base processing unit 36 adjusts base fog in accordance with the base adjustment data.

The above processing can be implemented by the MFP 1 alone without using the PC 211. For example, a document scanned by the scanner 2 is stored into the internal storage device 116 of the MFP 1 and each of the above base adjustments is executed in accordance with an operation input from the operation panel 112. The MFP 1 is equipped with a function called “Scan To Box” to store a document scanned by the scanner 2 into the internal storage device 116 of the MFP 1 and print out its data in accordance with an operation. Therefore, if the base adjustment function via the PC 211 is provided, base adjustment can be easily carried out by the MFP 1 alone.

According to the embodiments, base processing to a part of a document can be carried out inexpensively without using dedicated image processing software.

The processing operations shown in FIG. 11 to FIG. 14 can be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an adjustment data setting unit which sets base adjustment data used to readjust a density of a part having a lower density than a predetermined density of image data to a lower value with respect to a printer driver which generates print data;
a data input unit which receives the image data and the base adjustment data from the print driver; and
a base adjustment unit which executes base adjustment in a predetermined part of the image data in accordance with the base adjustment data;
wherein the base adjustment data includes information designating a data attribute of the predetermined part where base adjustment is carried out, and information designating a level of the base adjustment.

2. The apparatus according to claim 1, wherein the adjustment data setting unit sets a page to which the base adjustment data is applied, and
the base adjustment data further includes information corresponding to the page that is set.

3. The apparatus according to claim 1, wherein the adjustment data setting unit sets an area of the image data to which the base adjustment data is applied, and
the base adjustment data further include information corresponding to the area of the image data that is set.

4. The apparatus according to claim 1, wherein the adjustment data setting unit designates whether each data attribute is regarded as a target of base adjustment or not, and
the base adjustment data further includes information about whether a data attribute is regarded as a target of base adjustment, designated for each data attribute.

5. The apparatus according to claim 1, wherein the base adjustment unit converts the image data by using gradation characteristic adjustment data indicating a correspondence between input image data and base-adjusted output image data, and executes the base adjustment.

6. The apparatus according to claim 5, further comprising a characteristic adjustment data selecting unit which selects gradation characteristic adjustment data used for the base adjustment from plural types of the gradation characteristic data in accordance with the information designating the level of the base adjustment.

7. The apparatus according to claim 5, further comprising a characteristic adjustment data generating unit which generates, from two types of gradation characteristic adjustment data corresponding to two types of levels of the base adjustment, gradation characteristic adjustment data corresponding to an intermediate level of the two types of levels by arithmetic operation.

8. An image processing method comprising:
setting base adjustment data used to readjust a density of a part having a lower density than a predetermined density of image data to a lower value with respect to a printer driver which generates print data;
receiving the image data and the base adjustment data from the print driver; and
executing base adjustment in a predetermined part of the image data in accordance with the base adjustment data;
wherein the base adjustment data includes information designating a data attribute of the predetermined part where base adjustment is carried out, and information designating a level of the base adjustment.

9. The method according to claim 8, wherein in setting of the adjustment data, a page to which the base adjustment data is applied is set, and
the base adjustment data further includes information corresponding to the page that is set.

10. The method according to claim 8, wherein in setting the adjustment data, an area of the image data to which the base adjustment data is applied is set, and
the base adjustment data further include information corresponding to the area of the image data that is set.

11. The method according to claim 8, wherein in setting the adjustment data, it is designated whether each data attribute is regarded as a target of base adjustment or not, and
the base adjustment data further includes information about whether a data attribute is regarded as a target of base adjustment, designated for each data attribute.

12. The method according to claim 8, wherein in executing the base adjustment, the image data is converted by using gradation characteristic adjustment data indicating a correspondence between input image data and base-adjusted output image data.

13. The method according to claim 12, further comprising selecting gradation characteristic adjustment data used for the base adjustment from plural types of the gradation characteristic data in accordance with the information designating the level of the base adjustment.

14. The method according to claim 12, further comprising generating, from two types of gradation characteristic adjustment data corresponding to two types of levels of the base adjustment, gradation characteristic adjustment data corresponding to an intermediate level of the two types of levels by arithmetic operation.

15. An image forming apparatus comprising:
an input unit which inputs image data;
an adjustment data setting unit which sets base adjustment data used to readjust a density of a part having a lower density than a predetermined density of the image data to a lower value;
a data input unit which receives the image data and the base adjustment data;
a base adjustment unit which executes base adjustment in a predetermined part of the image data in accordance with the base adjustment data; and
an image forming unit which generates a printed matter from the base-adjusted image data;
wherein the base adjustment data includes information designating a data attribute of the predetermined part where base adjustment is carried out, and information designating a level of the base adjustment.

16. The apparatus according to claim 15, wherein the adjustment data setting unit sets a page to which the base adjustment data is applied, and
the base adjustment data further includes information corresponding to the page that is set.

17. The apparatus according to claim 15, wherein the adjustment data setting unit sets an area of the image data to which the base adjustment data is applied, and
the base adjustment data further include information corresponding to the area of the image data that is set.

18. The apparatus according to claim 15, wherein the adjustment data setting unit designates whether each data attribute is regarded as a target of base adjustment or not, and
the base adjustment data further includes information about whether a data attribute is regarded as a target of base adjustment, designated for each data attribute.
